(19) United States
(12) Patent Application Publication
(10) Pub. No.: US 2018/0238793 A1
(43) Pub. Date: Aug. 23, 2018

(54) LIGHT-ATTENUATION-RATIO MEASUREMENT METHOD AND LIGHT-INTENSITY MEASUREMENT SYSTEM

(71) Applicant: OLYMPUS CORPORATION, Tokyo (JP)

(72) Inventor: Hiroshi KOBAYASHI, Tokyo (JP)

(73) Assignee: OLYMPUS CORPORATION, Tokyo (JP)

(21) Appl. No.: 15/962,246

(22) Filed: Apr. 25, 2018

Related U.S. Application Data
(63) Continuation of application No. PCT/JP2015/081466, filed on Nov. 9, 2015.

(51) Int. Cl. G01N 21/25; G01N 21/84; G01N 21/59; G02B 5/20; G02B 5/22

(52) U.S. Cl. CPC G01N 21/255; G01N 21/8483; G02B 5/223; G02B 5/201; G01N 21/59

(57) ABSTRACT

A light-attenuation-ratio measurement method according to the present disclosure includes: a first step of placing a first light attenuator and a second light attenuator between a light source and a light-receiving portion and measuring a first intensity of transmitted light that has passed through the light attenuators, the first intensity being within a light-receiving sensitivity of the light-receiving portion; a second step of placing the second light attenuator and a target light attenuator between the light source and the light-receiving portion and measuring a second intensity of transmitted light that has passed through the light attenuators, the second intensity being within the light-receiving sensitivity of the light-receiving portion; and a third step of calculating a light attenuation ratio of the target light attenuator by multiplying or dividing an intensity ratio between the first intensity and the second intensity by a light attenuation ratio of the first light attenuator.

### CROSS-REFERENCE TO RELATED APPLICATIONS

This is a Continuation Application of International Application No. PCT/JP2015/081466 filed on Nov. 9, 2015, the content of which is hereby incorporated by reference herein in its entirety.

### TECHNICAL FIELD

The present invention relates to a light-attenuation-ratio measurement method and a light-intensity measurement system.

### BACKGROUND ART

There is a known light-intensity measurement system that irradiates an object-to-be-measured with light from a light source and that measures, by means of a light receiver, light that has been transmitted, reflected, scattered, or the like (for example, see Japanese Unexamined Patent Application, Publication No. 2012-251875 (PLT1)).

In this light-intensity measurement system, in order to ensure a large light-receiving dynamic range for the light receiver, a light attenuator is disposed between the object-to-be-measured and the light receiver, thus performing measurement by decreasing the intensity of light received by the light receiver. In addition, in the light-intensity measurement system of Japanese Unexamined Patent Application, Publication No. 2012-251875, a photon counter is employed as a light-receiving portion, the number of photons in the received light is counted, and the light attenuation ratio of the light attenuator is calibrated on the basis of the counting result.

### SUMMARY OF INVENTION

An aspect of the present disclosure is a light-attenuation-ratio measurement method comprising: a first step of placing a first light attenuator and a second light attenuator between a light source and a light-receiving portion that receives light coming from the light source, and measuring a first intensity of transmitted light that has passed through the light attenuators, the first intensity being within a light-receiving sensitivity of the light-receiving portion; a second step of placing the second light attenuator and a target light attenuator between the light source and the light-receiving portion and measuring a second intensity of transmitted light that has passed through the light attenuators, the second intensity being within the light-receiving sensitivity of the light-receiving portion; and a third step of calculating a light attenuation ratio of the target light attenuator by multiplying or dividing an intensity ratio between the first intensity and the second intensity by a light attenuation ratio of the first light attenuator.

In addition, another aspect of the present disclosure is a light-intensity measurement system including: a light-source unit that emits light that is irradiated onto an object-to-be-measured; a light-receiving portion that receives light that has been irradiated onto the object-to-be-measured; a first light reducer that is placed between the light-source unit and the light-receiving portion in order to attenuate light received by the light-receiving portion so as to fall within the light-receiving sensitivity of the light-receiving portion, the first light reducer capable of changing its light attenuation ratio; a second light reducer that can be placed at and removed from a position between the light-source unit and the light-receiving portion, the second light reducer capable of changing its light attenuation ratio; and a light attenuation-ratio calculator that, while changing the light attenuation ratios of the first light reducer and/or the second light reducer so as to fall within the light-receiving sensitivity of the light-receiving portion in a state in which the second light reducer is placed at the position, acquires a plurality of intensity ratios of the light received by the light-receiving portion before and after changing the light attenuation ratio of the first light reducer, and that calculates light attenuation ratios of the first light reducer by multiplying the intensity ratios, the light attenuation ratios of the first light reducer are calculated in ascending order of the light attenuation ratios.

### BRIEF DESCRIPTION OF DRAWINGS

FIG. 1 is an overall configuration diagram showing a light-intensity measurement system according to an embodiment of the present invention.

FIG. 2 is a block diagram showing the connection between a controller of the light-intensity measurement system in FIG. 1 and other components thereof.

FIG. 3 is a front view showing an example of a light reducer provided in the light-intensity measurement system in FIG. 1.

FIG. 4 is a graph showing examples of light attenuation ratios of light attenuators provided in the light reducer in FIG. 3.

FIG. 5 is a flowchart for explaining a light-attenuation-ratio measurement method according to an embodiment of the present invention.

FIG. 6 is a table showing example data acquired by using the light-attenuation-ratio measurement method in FIG. 5.

FIG. 7 is a flowchart for explaining a light-intensity measurement method used by the light-intensity measurement system in FIG. 1.

FIG. 8 is a graph showing light-intensity characteristics in which light intensities acquired by using the light-intensity measurement method in FIG. 7 are subjected to joining processing.

FIG. 9 is a front view showing a modification of the light reducer in FIG. 3.

FIG. 10 is a graph showing examples of light attenuation ratios of a light attenuator provided in the light reducer in FIG. 9.

FIG. 11 is a flowchart showing a modification of the light-attenuation-ratio measurement method in FIG. 5.

FIG. 12 is a flowchart showing another modification of the light-attenuation-ratio measurement method in FIG. 5.

FIG. 13 is a table showing example light attenuation ratio data for separate wavelengths acquired, on the basis of FIG. 12.

### DESCRIPTION OF THE EMBODIMENTS

A light-intensity measurement system 1 according to an embodiment of the present invention will be described below with reference to the drawings.

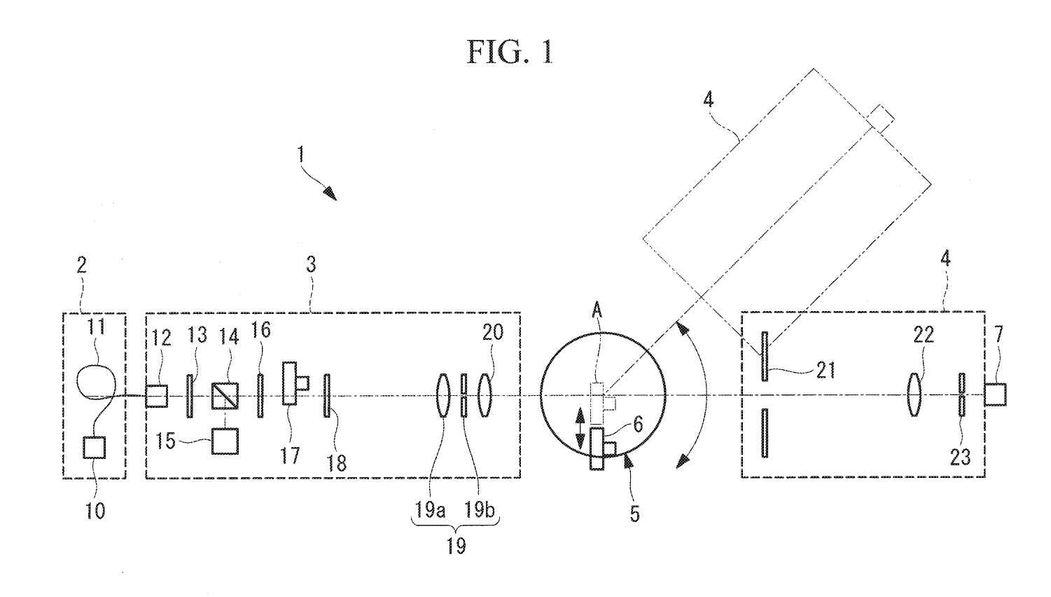

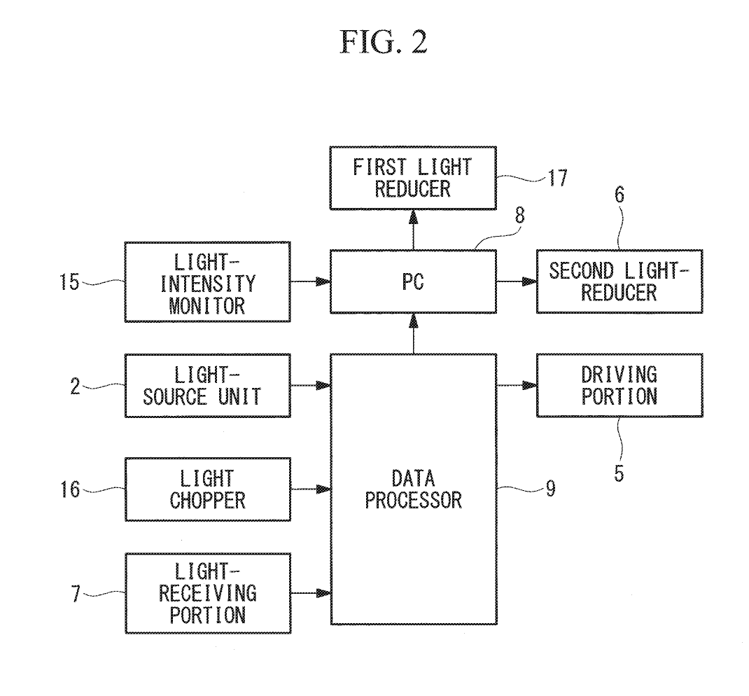

As shown in FIGS. 1 and 2, the light-intensity measurement system 1 according to this embodiment is provided with: a light-source unit 2; an illumination optical system 3; a light-receiving optical system 4; a driving portion 5 that drives the light-receiving optical system 4; a light reducer (hereinafter, referred to as the second light reducer) 6 that is inserted into and removed from an optical path; a light-receiving portion 7; and a controller 8.

As shown in FIG. 2, the light-source unit 2, a light-intensity monitor 15 (described later), a light chopper 16 (described later), the driving portion 5, a first light reducer 17 (described later), the second light reducer 6, and the light-receiving portion 7 are connected, via a data processor 9 or directly, to a controller (a PC, a relative-light-attenuation-ratio calculator, a light-attenuation-ratio calculator) 8.

The light-source unit 2 is provided with a laser diode (LD) 10 that emits light and an optical fiber 11 that guides the light from the laser diode 10. A laser light source, a halogen light source, an LED, or the like may be employed instead of the laser diode 10.

The illumination optical system 3 is provided with: a collimating lens 12 that converts the light emitted from the optical fiber 11 to substantially collimated light; a first waveplate 13; a polarization beam splitter (PBS) 14; the light-intensity monitor 15 that detects light that has been split off by the polarization beam splitter 14; the light chopper 16; the light reducer (hereinafter, referred to the first light reducer) 17; a second waveplate 18; a spatial filter 19; and a focusing lens 20.

The first waveplate 13 is a 1/2-wave plate and has a function of controlling the polarization direction of the light transmitted thereto from the light-source unit 2 before allowing the light to be incident on the polarization beam splitter 14.

In the polarization beam splitter 14, of the incident light, light having a polarization component in which the polarization direction has been controlled to be in the specific direction by means of the first wavelength plate 13 is allowed to pass therethrough as measurement light, and light having other polarization components is reflected toward the light-intensity monitor 15. Because of this, by controlling the polarization direction before allowing the light to enter the polarization beam splitter 14, the proportion of light which is separated by the polarization beam splitter 14 is changed, and thus, loss of measurement light is prevented.

A portion of the light separated by the polarization beam splitter 14 reaches the light-intensity monitor 15. The light-intensity monitor 15 is used to measure the stability of the intensities of the light of the laser diode 10. By feeding the amounts of changes in the light intensities detected by the light-intensity monitor 15 back to the measurement results in the light-receiving portion 7, it is possible to enhance the measurement precision.

Mi/M0=ΔMi

Here, Mi is the value measured by the light-intensity monitor 15 simultaneously with measuring the intensity of the object-to-be-measured A, and M0 is the value measured by the light-intensity monitor 15 when measurement is started.

By calculating the rate of change ΔMi and by multiplying the light-intensity measurement result of the object-to-be-measured A thereby, it is possible to decrease fluctuations of the measured values of the light intensities caused by heat from the laser diode 10 or the like.

In this way, because it suffices so long as it is possible to measure rate of changes in the intensities of light that have reached the light-intensity monitor 15, a large light-receiving dynamic range is not required, and thus, it is preferable to employ a low-cost photodetector (PD) that is easy to use.

The light chopper 16 has the function of modulating the light. The measurement light is modulated into light having a specific frequency by the light chopper 16 and the light received by the light-receiving portion 7 is processed by means of a lock-in amplifier (synchronous detection technique), whereby it is possible to attenuate light having frequencies that are different from the modulation frequency, such as external light, electrical noise, or the like, by means of a narrow-band filter. By doing so, it is possible to measure weak light such as scattered light.

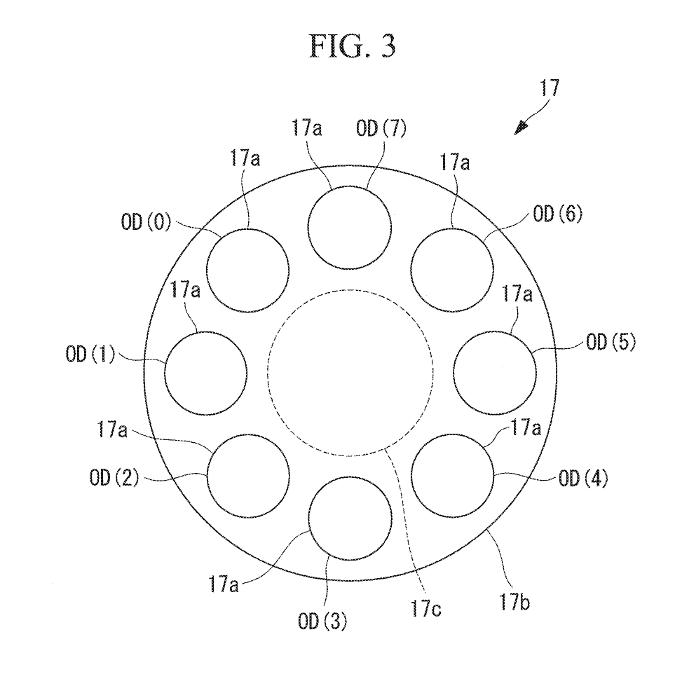

As shown in FIG. 3, the first light reducer 17 is provided with a plurality of (for example, eight) light attenuators 17a that are arrayed in a circumferential direction; a turret 17b that can alternatively place the light attenuators 17a in the optical path; and a motor 17c that rotates the turret 17b. Here, for the sake of convenience of describing the invention, the light attenuators 17a refer to ND filters that have a wide range of light attenuation ratios and with which it is possible to set from a large light attenuation ratio to a small light attenuation ratio. Alternatively, so long as it is possible to selectively attenuate the light, it is permissible to use arbitrary light attenuators 17a such as a pinhole, liquid crystal, or combinations thereof.

In the light-intensity measurement system 1, one of the light attenuators 17a of the first light reducer 17 is placed in the optical path, and the light emitted from the light-source unit 2 is attenuated so as to reach a light intensity that can be received by the light-receiving portion 7, thus a measurement is performed. By multiplying the intensity of the light received by the light-receiving portion 7 by the inverse of the light attenuation ratio of the light attenuator 17a, it is possible to calculate the absolute value of the light intensity.

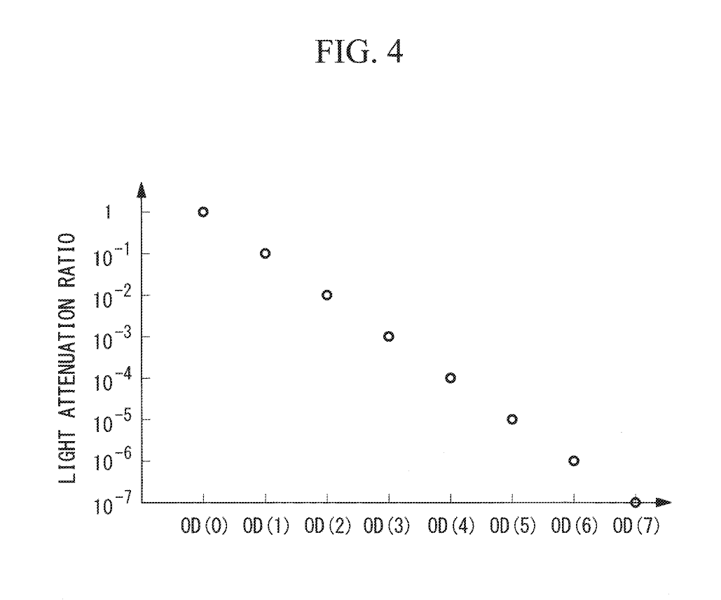

FIG. 4 shows changes in the light attenuation ratios when switching among the light attenuators 17a of the light reducer 17. Because the light attenuators 17a are switched from one to another in accordance with the rotational angle of the turret 17b, the light intensity of the illumination light is changed stepwise.

Here, as the light attenuators 17a that are adjacent to each other in a circumferential direction in the first light reducer 17, light attenuators in which light attenuation ratios change by increments of 1/10 are employed.

In addition, as the one of the light attenuators 17a of the first light reducer 17, a light attenuator made of air, a substance having a refractive index that is the same as that of the measurement environment, which serve as a reference for the calculation of the light attenuation ratio, a light attenuator made of a substance having the same reflectance as those of the other light attenuators 17a and having a transmittance of substantially 100% (light attenuation ratio of 1), or a light attenuator made of a substance having a known refractive index and/or light attenuation ratio is provided.

In the case in which it is necessary to calculate the light attenuation ratios of the light attenuators 17a in a state in which the light attenuators are installed in the system, it is preferable to employ light attenuators made of air or a substance having a refractive index that is the same as that of the measurement environment. In addition, in the case in which it is necessary to calculate a light attenuation ratio of a single light attenuator 17a, it is preferable to employ a light attenuator made of a substance having a reflectance that is the same as those of the other light attenuators 17a and having a transmittance of substantially 100% or a substance having a known refractive index and/or light attenuation ratio. These settings reflect a difference in terms of whether or not the reflectances should be considered when the light attenuators 17a are installed.

The second waveplate 18 is a 1/2-wave plate, and is capable of arbitrarily changing the polarization direction of the measurement light with respect to the object-to-be-measured A.

The spatial filter 19 is formed of an objective lens 19a and a pinhole 19b so as to be capable of removing noise light (unwanted light) from the measurement light.

The focusing lens 20 has a function for controlling the light that enters the object-to-be-measured A. In the case in which an intensity distribution of scattered light is measured, the location at which the incident light is focused is important. Here, although the focal point is set to be disposed in the vicinity of an aperture (described later) in order to enhance the angular resolution at an incident-light-intensity peripheral portion, it is preferable to allow arbitrary adjustment of this setting.

The light-receiving optical system 4 is provided with an aperture 21 that allows the light to enter therethrough; a focusing lens 22 that focuses the light that has passed through the aperture 21; and a field stop 23 that is disposed in the vicinity of the focusing position of the focusing lens 22.

The aperture 21 has the function of determining the measurement solid angle, and the focusing lens 22 and the field stop 23 control the spatial resolution in a measurement region, thus making it possible to decrease unwanted light from other regions.

The light-receiving portion 7 is, for example, a sensor such as a photomultiplier tube (PMT), an avalanche photodiode (APD), or a photodiode (PD).

The driving portion 5 is provided with a motor (not shown) that integrally rotates the light-receiving optical system 4 and the light-receiving portion 7 about a vertical axis that is orthogonal to the optical axis of the illumination optical system 3.

The second light reducer 6 also has a configuration that is similar to that of the first light reducer 17, has the turret 17b in which the plurality of light attenuators 17a are arrayed in the circumferential direction thereof so that, in a state in which the second light reducer 6 is placed in the optical path, one of the light attenuators 17a is selectively placed in the optical path by means of the motor 17c.

In this embodiment, the second light reducer 6 is placed in and removed from the optical path by moving the second light reducer 6 itself. The position at which the second light reducer 6 is inserted and removed may be an arbitrary position between the light-source unit 2 and the light-receiving portion 7. In the figure, the second light reducer 6 is installed by being switched into the position at which the object-to-be-measured A is placed.

Next, a light-attenuation-ratio measurement method according to the embodiment of the present invention will be described.

The light-attenuation-ratio measurement method according to this embodiment is a method of measuring the light attenuation ratios of the individual light attenuators 17a of the first light reducer 17.

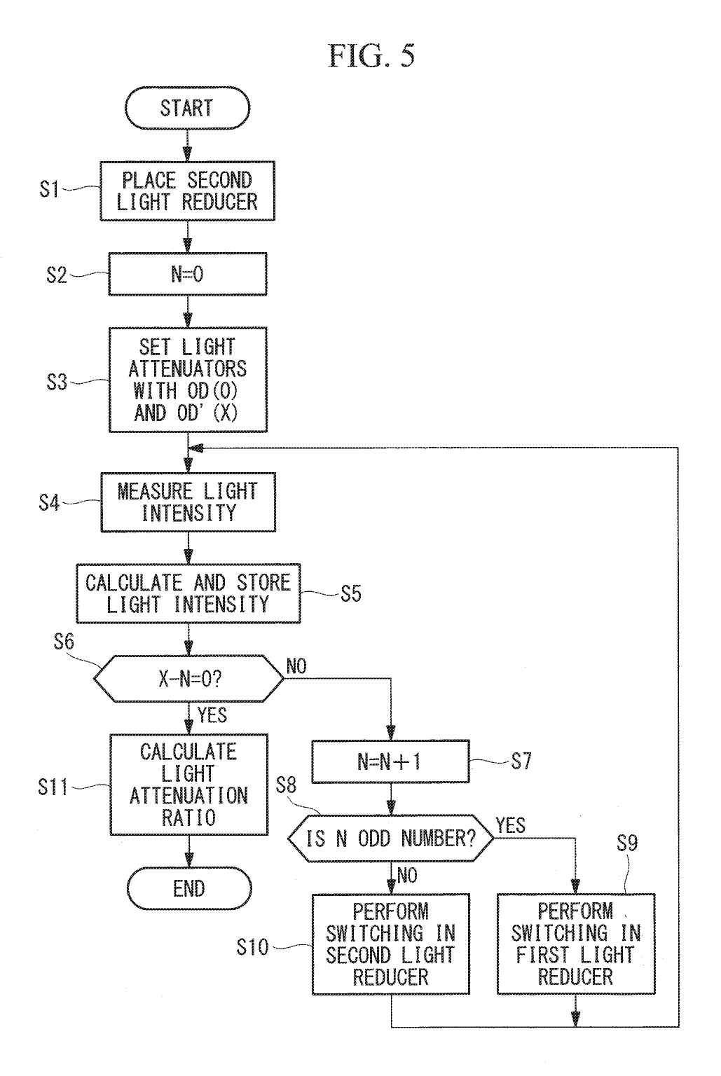

First, as shown in FIGS. 1 and 5, in a state in which the object-to-be-measured A is not placed in the optical path, the second light reducer 6 is placed in the optical path (step S1), and N is set to an initial value of 0 (step S2).

Next, in the first light reducer 17, the light attenuator (air) 17a having a light attenuation ratio OD(0)=1 is placed in the optical path, and, in the second light reducer 6, the light attenuator (third light attenuator) 17a having a maximum light attenuation ratio OD′ (X) to be used is placed in the optical path (step S3). Here, X indicates the number of light attenuators 17a which are being used.

Next, light is emitted from the light-source unit 2, transmitted light that has passed through the two light attenuators 17a is received by the light-receiving portion 7 and the light intensity thereof is measured (step S4), and a value PW(0) (third light intensity) obtained by multiplying the measurement light intensity by the rate of change ΔMi is calculated and stored (step S5).

Subsequently, it is determined (step S6) whether or not all the measurements have been completed; in the case in which measurements have not been completed, N is incremented (step S7) and whether or not N is an odd number is determined (step S8); and, in the case in which N is an odd number, without switching the light attenuator 17a of the second light reducer 6, the light attenuator 17a of the first light reducer 17 is switched to the light attenuator (first light attenuator) 17a having a light attenuation ratio OD(1), thus increasing the light attenuation ratio of the light attenuator 17a of the first light reducer 17 by one level (step S9), the light intensity is measured (step S4), and a value PW(1) (fourth light intensity) obtained by multiplying the measurement light intensity by the rate of change ΔMi is calculated and stored (step S5).

In step S8, in the case in which N is an even number, the light attenuator 17a of the second light reducer 6 is switched, without switching the light attenuator 17 of the first light reducer 17, to the light attenuator 17a (second light attenuator) having a light attenuation ratio OD′ (X−1), thus decreasing the light attenuation ratio of the light attenuator 17a of the second light reducer 6 by one step (step S10), the light intensity is measured (step S4), and a value PW(2) (first light intensity) obtained by multiplying the measurement light intensity by the rate of change ΔMi is calculated and stored (step S5).

These operations are repeated until X−N=0 is achieved, in other words, until a light attenuation ratio OD′ (0) of the light attenuator 17a of the second light reducer 6 is reached.

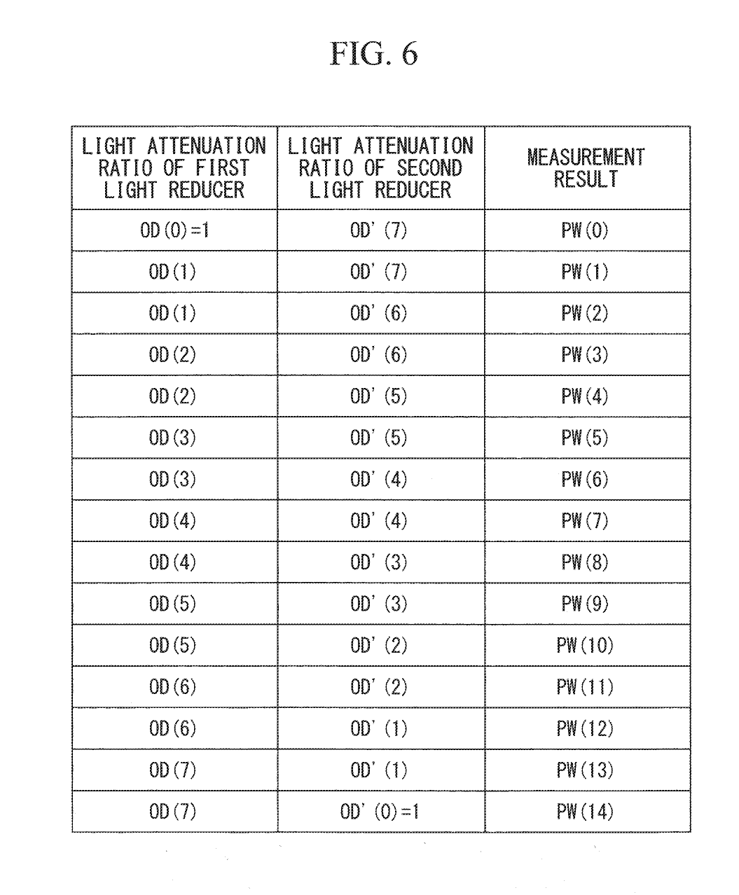

By doing so, the data shown in FIG. 6 is obtained.

Next, by using the obtained data, the light attenuation ratios of the light attenuators 17a of the first light reducer 17 are sequentially calculated starting from smaller values, and the calculation results are utilized when calculating the light attenuation ratios of the subsequent light attenuator 17a, as below (step S11).

OD(1)=PW(1)/PW(0)×OD(0)

OD(2)=PW(3)/PW(2)×OD(1)

Expressing these operations by a general expression yields

OD(Y)=PW(Z)/PW(Z−1)×OD(Y−1)

where, Y is an integer 1,2,3, . . . ,7 and Z is an integer 1,3,5, . . . ,13.

As has been described above, with the light-attenuation-ratio measurement method according to this embodiment, because the light attenuation ratios are calculated by utilizing the light intensities obtained by receiving the transmitted light that has passed through the two light attenuators 17a, large fluctuations in the total light attenuation ratio resulting from the combination of the light attenuators 17a is prevented. As a result, it is possible to decrease the range of the intensities of the light received by the light-receiving portion 7, and thus, there is an advantage in that, even if a sensor having a small light-receiving dynamic range is used as the sensor of the light-receiving portion 7, it is possible to measure the light attenuation ratios of the light attenuators 17a in a highly precise manner.

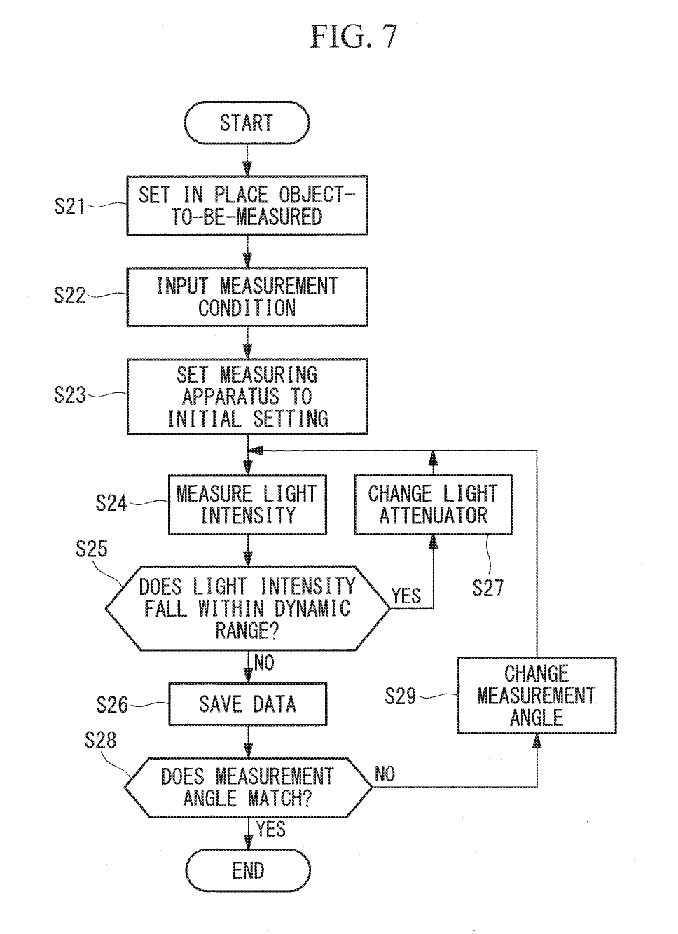

Next, the operation of the light-intensity measurement system 1 according to this embodiment will be described below by using FIG. 7.

In order to measure the transmission or the reflection characteristics or the like of the object-to-be-measured A by using the light-intensity measurement system 1 according to this embodiment, as indicated by chain lines in FIG. 1, the second light reducer 6 is removed from the optical path, and, instead, the object-to-be-measured A is placed in the optical path, as indicated by chain lines in FIG. 1 (step S21).

Next, measurement conditions are input (step S22). The measurement conditions include, the wavelength of the measurement light to be irradiated onto the object-to-be-measured, the polarization conditions, the incident angle, the incident location, the incident region, the measurement angle, etc. In addition, in the case in which a light-intensity distribution is to be acquired, a measurement area (a single cross-section or a three-dimensional area including multiple cross-sections), a measurement-angle range, and a measurement resolution (pitch) are additionally included. Furthermore, in the case in which fluorescence or the like is to be observed, the presence/absence of a filter is included in the measurement conditions.

The settings of the light-intensity measurement system 1 are changed on the basis of the input measurement conditions.

In addition, an appropriate light attenuator 17a is selected so as to serve as the light attenuator 17a of the first light reducer 17 (step S23).

Next, the measurement light that has been emitted from the light-source unit 2 and that has passed through the illumination optical system 3 is irradiated onto the object-to-be-measured A, acts on the object-to-be-measured A, resulting in the light that is received by the light-receiving portion 7 after passing through the light-receiving optical system 4 (step S24).

Next, whether or not the light received by the light-receiving portion 7 is within the light-receiving dynamic range of the light-receiving portion 7 is determined by means of comparison against a threshold (step S25), and, in the case in which the received light is within the light-receiving dynamic range, the measured light intensity is saved together with the measurement conditions, the light attenuation ratio of the light attenuator 17a, and the rate of change ΔMi of the light-intensity monitor 15 (step S26).

In the case in which the received light is outside the light-receiving dynamic range, the light attenuator 17a of the first light reducer 17 is switched to another light attenuator 17a (step S27), and processing from step S24 is repeated

In step S27, in the case in which the received light exceeds an upper-limit threshold, the light attenuator 17a is switched to another light attenuator 17a having a greater light attenuation ratio, and, in the case in which the received light does not reach a lower-limit threshold, the light attenuator 17a is switched to another light attenuator 17a having a lower light attenuation ratio.

Next, whether or not the measurement angle is consistent with the set measurement condition is determined (step S28), and, in the case in which the measurement angle is not consistent with the set measurement condition, the light-receiving optical system 4 and the light-receiving portion 7 are integrally pivoted by means of actuation of the driving portion 5, thus changing the measurement angle (step S29), and then, the processing from step S24 is repeated. In the case in which the measurement angle is consistent with the set measurement condition, the processing is terminated.

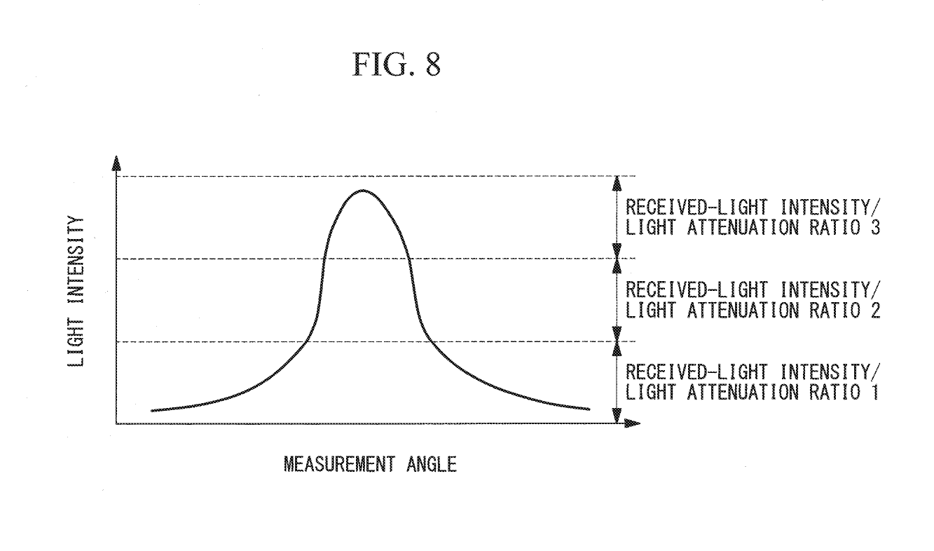

Next, a method of processing the acquired measurement result is shown in FIG. 8.

By multiplying the stored light intensity by the inverse of the light attenuation ratio stored in association with the light intensity, the original light intensity is calculated. Then, on the basis of the measurement angle, which is similarly stored in association with the light intensity, joining processing (stitching processing) is performed. By doing so, it is possible to acquire a light-intensity distribution, as shown in FIG. 8.

In this case, with this embodiment, because the light attenuation ratio of the light attenuator 17a is measured in a highly precise manner, it is possible to achieve smooth continuous joining in which displacements (errors) at joined portions caused by joining processing are reduced.

In addition, with this embodiment, by using the light-receiving portion 7 having a small light-receiving dynamic range, it is possible to ensure a large light-receiving dynamic range in which light can substantially be received, and thus, there is an advantage that it is possible to measure, in a highly precise manner, light intensities and a light-intensity distribution thereof for substances having low scattered-light intensities to substances having high scattered-light intensities. In addition, there is also an advantage that it is possible to employ a low-cost sensor having a small light-receiving dynamic range.

Note that, in the light-intensity measurement system 1 according to this embodiment, although the second light reducer 6 itself is placed in and removed from the optical path by being switched with the object-to-be-measured A, alternatively, the second light reducer 6 may be placed in a location that is different from the position at which the object-to-be-measured A is placed, a hole or a light attenuator 17a having a light attenuation ratio of 1 may be provided in one location in the array of the light attenuators 17a of the second light reducer 6, and, by placing the hole or the light attenuator 17a having the light attenuation ratio of 1 in the optical axis when measuring the object-to-be-measured A, a state that is the same as the state in which the second light reducer 6 itself is removed, that is, a state in which the measurement light is not attenuated, may be achieved.

In addition, in this embodiment, by providing a hole in which a light attenuator 17a is not disposed at one location in the array of the light attenuators 17a in the case in which the second light reducer 6 is placed at the position of the object-to-be-measured A, the object-to-be-measured A may be mounted in the hole when measuring the object-to-be-measured A.

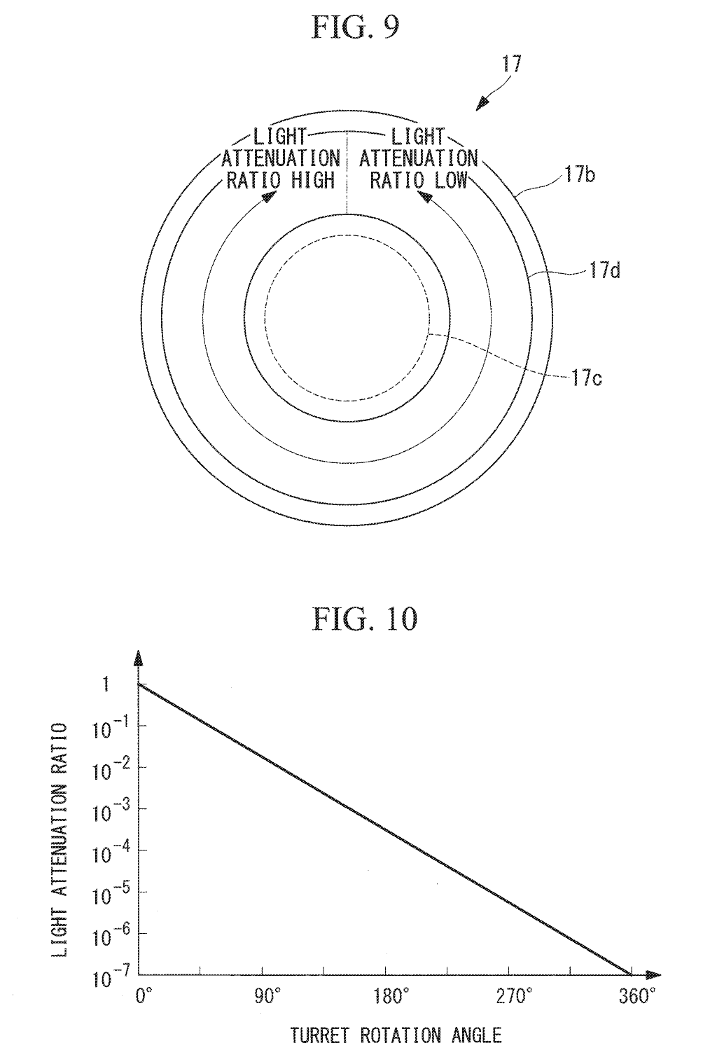

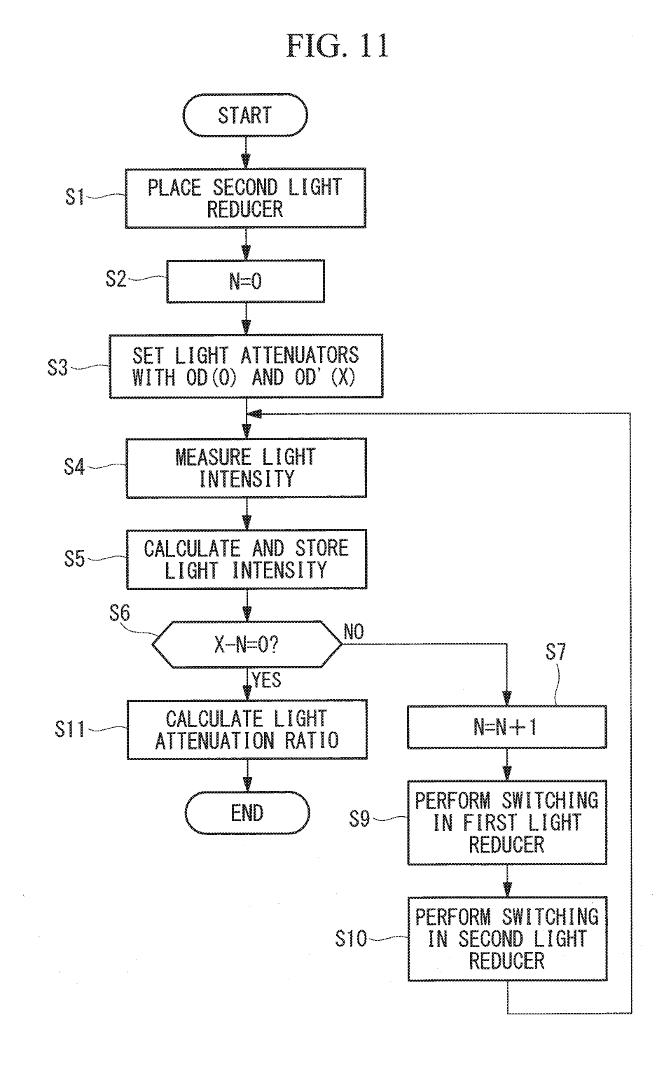

In addition, in this embodiment, although the turret 17b in which the plurality of light attenuators 17a having different light attenuation ratios arrayed in the circumferential direction has been described as an example, alternatively, as shown in FIG. 9, a variable ND filter 17d in which the light attenuation ratio thereof continuously changes in a circumferential direction may be employed. By accurately setting the rotational angle of the turret 17b with respect to a luminous flux, it is possible to finely change, in a continuous manner, the intensity of the light entering the object-to-be-measured A. FIG. 10 shows the relationship between the rotational angles of the turret 17b and the light attenuation ratios in this case.

In addition, in this embodiment, although the light attenuation ratios of adjacent light attenuators 17a are changed in 1/10 increments in the circumferential direction, the ratio of this change may be arbitrary. For example, the light attenuation ratios may be changed in increments of 1/100, or may be changed by an even smaller ratio such as 1/2 or 1/5. In the case in which a sensor having a small light-receiving dynamic range is used, by changing the light attenuation ratios by a small ratio, the number of times measured data are joined is increased, and thus, it is possible to increase the light-receiving dynamic range.

In addition, although the light-attenuation-ratio measurement method according to this embodiment has been described in terms of, as an example, the case in which the light attenuation ratios of the light attenuators 17a of the first light reducer 17 are calculated. Because the second light reducer 6 is not used to measure the light intensity with respect to the object-to-be-measured A, it is not necessary to calculate the light attenuation ratios thereof in a highly precise manner; however, it is possible to also calculate the light attenuation ratios of the light attenuators 17a of the second light reducer 6 at the same time as those of the light attenuators 17a of the first light reducer 17 are calculated.

The method of calculating the light attenuation ratios of the light attenuators 17a of the second light reducer 6 is as follows:

OD′(Y)=PW(Z′−1)/PW(Z′)×OD′(Y−1)

where Z′ indicates the integers i(max),i(max)−2, . . . . The maximum number of light-intensity measurements is indicated by i(max).

Also, by saving the measured light attenuation ratios of the light attenuators 17a of the second light reducer 6, there is an advantage in that it is possible to simplify the procedures for calculating the light attenuation ratios when the first light reducer 17 is exchanged with another unit.

In other words, as shown in FIG. 11, at the same time as increasing the light attenuation ratio of the first light reducer 17 by one level in step S9, processing for decreasing the light attenuation ratio of the second light reducer 6 by one level is performed in step S10. By doing so, it is possible to acquire measurement results PW(i). Here, i=2,4,6, . . . ,14.

Then, OD(Y) is calculated by using the following expression:

OD(Y)=PW(i)/Pin/OD′(Y′)

where Y is an integer 1,2, . . . ,7, Y′ is the an integer 6, . . . ,1, and i=2,4,6, . . . ,14. In addition, Pin is the intensity of the incident light, which is calculated as Pin=PW(0)/OD′(7)/OD(0), where the light attenuation ratio OD(0)=1.

As has been described above, the light intensities Pin of the incident light are calculated by utilizing the light attenuation ratios of the second light reducer 6, which have already been calculated and stored, and then, it is possible to calculate the light attenuation ratios of the first light reducer 17 by utilizing Pin and the light attenuation ratios of the second light reducer 6. By doing so, there is an advantage in that it is possible to decrease the number of measurements by half.

In addition, the above-described method can be applied to the case in which some of the light attenuation ratios of the first light reducer 17 or second light reducer 6 are known.

The case in which some of the light attenuation ratios are known refers to a case in which, for example, the light attenuation ratios are already known in a highly precise manner on the basis of a catalog specification or the like. For example, with the units having relatively high light attenuation ratios, such as 1/10, 1/100, or 1/1000, highly precise light attenuation ratios are guaranteed in many cases.

Furthermore, when identical light attenuators 17a from the same manufacturing lot are used in the first light reducer 17 and the second light reducer 6, measurements are repeatedly taken in step S4 until the light attenuation ratio of the first light reducer 17 and the light attenuation ratio of the second light reducer 6 match each other. In other words, when OD(i) is an integer 0,1,2, . . . ,X) and OD′ (k) (k=X,X−1,X−2, . . . ,0), measurements are repeatedly taken until i=k is achieved.

Also, until i−k is achieved, the light attenuation ratios are calculated as follows:

OD(p)=PW(s)/PW(s−1)×OD(p−1)

where s is an integer 1,3,5, . . . , and p is an integer 1,2,3, . . . , and,
after i=k is achieved, the light attenuation ratios are calculated as follows:

OD′(v+1)=PW(t−1)/PW(t)×OD′(v)

where t is an integer m−1,m−3, . . . ,0, and m is the maximum number of measurements,

v=i,i+1,i+2, . . . ,X, and OD(i)=OD′(i).

By doing so, it is possible to decrease the number of measurement by half.

In addition, in this embodiment, although the two light reducers 6 and 17 are provided, three or more light reducers may be provided.

When it is known, in advance, that the transmittance of the object-to-be-measured A is low, there are cases in which light attenuators 17a having high light attenuation ratios with respect to the intensity of the light coming from the light-source unit 2 are not installed in the light-intensity measurement system 1. In addition, when the intensity of the light coming from the light-source unit 2 is high, there are cases in which light attenuators 17a having a high enough light attenuation ratio cannot be acquired. In such cases, there are cases in which it is not possible to measure the light attenuation ratio of the light attenuator 17a that serves as a reference by using the above-described light-attenuation-ratio measurement method.

In other words, in the case in which the light-receiving dynamic range of the light-receiving portion 7 is exceeded when only the light-source unit 2 and light attenuators 17a are used, it is preferable to install a third light attenuator (not shown) when measuring the light attenuation ratio of the light attenuator 17a that serves as the reference. The light attenuation ratio of this third light attenuator does not need to be known in a highly precise manner, and it is acceptable so long as the light intensity of the light that has passed through the light attenuators 17a of the first light reducer 17 and the second light reducer 6 and the third light attenuator has a light attenuation ratio that approximately is within the light-receiving dynamic range of the light-receiving portion 7.

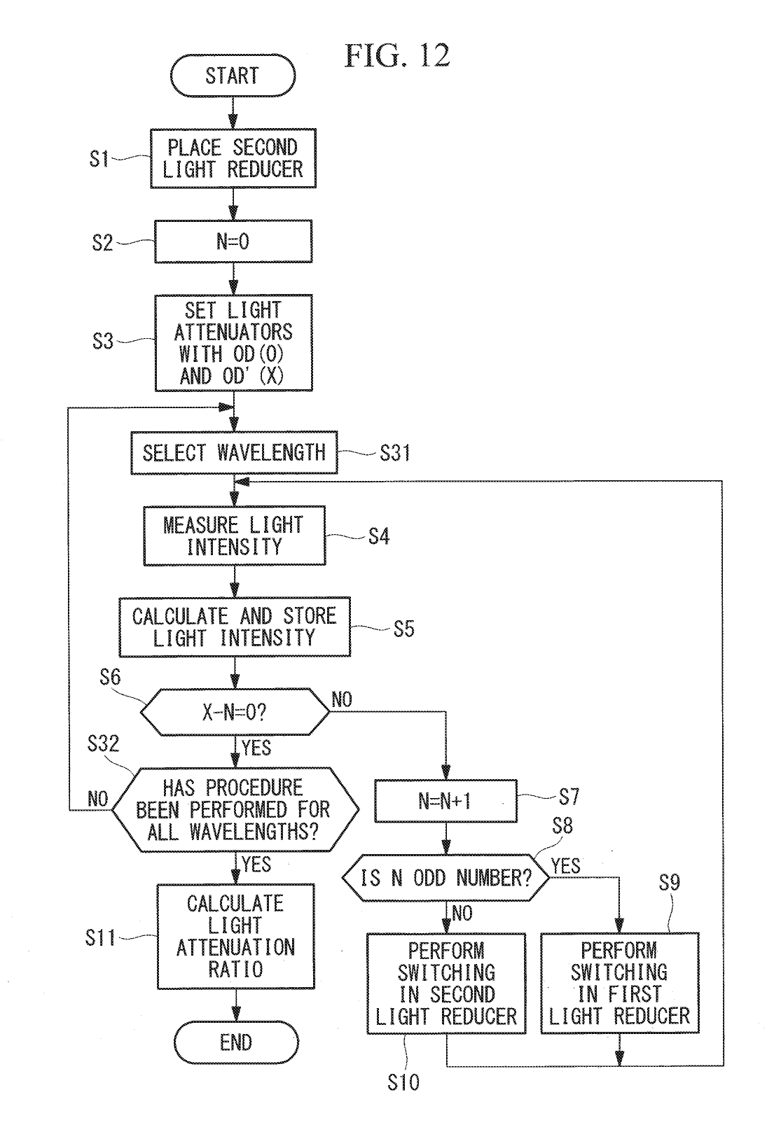

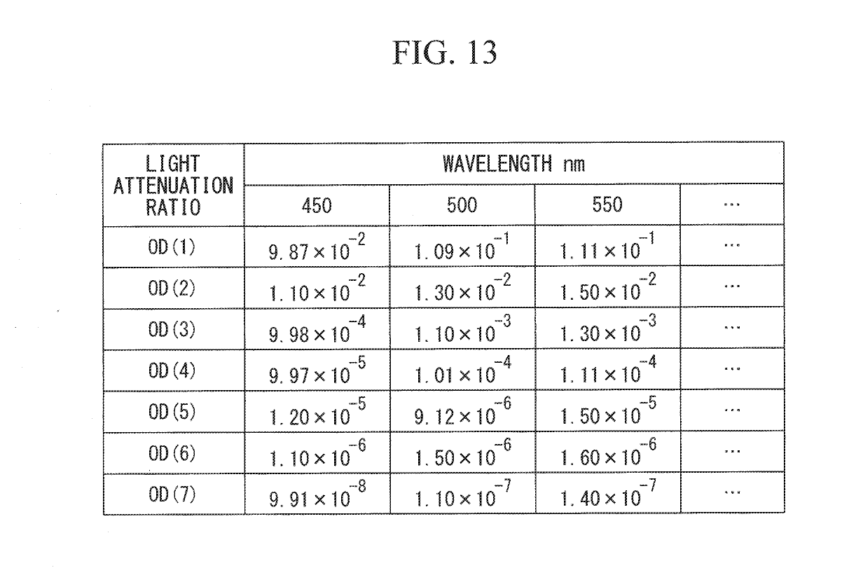

In addition, because light attenuators 17a such as ND filters are known to be wavelength dependent, as shown in FIG. 12, by adding a step S31 of selecting a wavelength of the illumination light before step S4 and step S32 of repeating the processing from step S31 for all wavelengths, it is possible to measure, in a highly precise manner, the light attenuation ratios of the light attenuators 17a for the individual wavelengths to be utilized. It is preferable that the measured light attenuation ratios be saved in a look-up table, as shown in FIG. 13.

From the above-described embodiments, the following aspects of the present invention are derived.

An aspect of the present disclosure is a light-attenuation-ratio measurement method comprising: a first step of placing a first light attenuator and a second light attenuator between a light source and a light-receiving portion that receives light coming from the light source, and measuring a first intensity of transmitted light that has passed through the light attenuators, the first intensity being within a light-receiving sensitivity of the light-receiving portion; a second step of placing the second light attenuator and a target light attenuator between the light source and the light-receiving portion and measuring a second intensity of transmitted light that has passed through the light attenuators, the second intensity being within the light-receiving sensitivity of the light-receiving portion; and a third step of calculating a light attenuation ratio of the target light attenuator by multiplying or dividing an intensity ratio between the first intensity and the second intensity by a light attenuation ratio of the first light attenuator.

With this aspect, the first intensity of transmitted light that has passed through the first light attenuator and the second light attenuator is measured in the first step, the second intensity of transmitted light that has passed through the second light attenuator and the target light attenuator is measured in the second step, and the light attenuation ratio of the target light attenuator is calculated in the third step on the basis of the light attenuation ratio of the first light attenuator, the first intensity, and the second intensity.

With this aspect, because measurements are taken, in both the first step and the second step, by having the two light attenuators in place, if the ratio between the light attenuation ratio of the target light attenuator and that of the first light attenuator is low, it is possible to perform the measurements within the light-receiving sensitivity of the light-receiving portion in both steps by means of combinations with the second light attenuator. Also, because the ratio between the light attenuation ratio of the first light attenuator and that of the target light attenuator is obtained on the basis of transmitted-light intensities measured in the two steps, it is possible to calculate, in a highly precise manner, the light attenuation ratio of the target light attenuator in the third step on the basis of that ratio and the light attenuation ratio of the first light attenuator.

The above-described aspect further includes: a fourth step of placing a third light attenuator between the light source and the light-receiving portion and measuring a third intensity of transmitted light that has passed through the third light attenuator, the third intensity being within the light-receiving sensitivity of the light-receiving portion; a fifth step of placing the third light attenuator and the first light attenuator between the light source and the light-receiving portion, and measuring a fourth intensity of transmitted light that has passed through the light attenuators, the fourth intensity being within the light-receiving sensitivity of the light-receiving portion; and a sixth step of calculating a light attenuation ratio of the first light attenuator on the basis of the third intensity and the fourth intensity.

By doing so, in the sixth step, it is also possible to calculate, in a highly precise manner, the light attenuation ratio of the first light attenuator to be used to calculate the light attenuation ratio of the target light attenuator on the basis of the third intensity of transmitted light that has passed through the third light attenuator, which is placed alone and that has a light attenuation ratio that allows the third intensity to be measured within the light-receiving sensitivity of the light-receiving portion, and the fourth intensity measured by placing the third light attenuator and the first light attenuator.

In addition, in the above-described aspect, it is preferable that the light attenuation ratio of the target light attenuator be greater than the light attenuation ratio of the first light attenuator.

By doing so, it is possible to measure, in a highly precise manner, the light attenuation ratio of a target light attenuator having a high light attenuation ratio that is difficult to measure by using a conventional method.

In addition, in the above-described aspect, it is preferable that a light attenuation ratio of the third light attenuator be greater than a light attenuation ratio of the second light attenuator, that the light attenuation ratio of the second light attenuator be greater than the light attenuation ratio of the target light attenuator, and that the light attenuation ratio of the target light attenuator be greater than the light attenuation ratio of the first light attenuator.

By doing so, by setting the light attenuation ratio of the third light attenuator to be the highest, it is possible to easily measure the third intensity within the light-receiving sensitivity of the light-receiving portion by placing the third light attenuator alone in the optical path. Thus, it is possible to easily measure the fourth intensity within the light-receiving sensitivity of the light-receiving portion by placing the first light attenuator having the lowest light attenuation ratio and the third light attenuator in the optical path.

In addition, in the above-described aspect, the fourth step and the fifth step may be executed before executing the first step and the sixth step may be executed before executing the third step, in the second step, the target light attenuator may be placed between the light source and the light-receiving portion instead of the first light attenuator, and, in the first step, the second light attenuator may be placed between the light source and the light-receiving portion instead of the third light attenuator.

By doing so, after receiving the light having the first intensity in the first step, it is possible to receive the light having the second intensity just by placing, in the second step, the target light attenuator instead of the first light attenuator without moving the second light attenuator. In addition, in the first step, it is possible to receive the light having the first intensity just by placing the second light attenuator instead of the third light attenuator without moving the first light attenuator.

In addition, the above-described aspect, further comprises a seventh step of setting the wavelength of the light emitted from the light source before executing the fourth step; and an eighth step of repeating, after executing the third step, the fourth step, the fifth step, the sixth step, the first step, the second step, and the third step after changing the wavelength of the light emitted from the light source.

By doing so, with a wavelength-dependent light attenuator, it is possible to measure, in a highly precise manner, light attenuation ratios for separate wavelengths of the light to be utilized.

In addition, another aspect of the present disclosure is a light-intensity measurement system including: a light-source unit that emits light that is irradiated onto an object-to-be-measured; a light-receiving portion that receives light that has been irradiated onto the object-to-be-measured; a first light reducer that is placed between the light-source unit and the light-receiving portion in order to attenuate light received by the light-receiving portion so as to fall within the light-receiving sensitivity of the light-receiving portion, the first light reducer capable of changing its light attenuation ratio; a second light reducer can be placed at and removed from a position between the light-source unit and the light-receiving portion, the second light reducer capable of changing its light attenuation ratio; a relative-light attenuation-ratio calculator that, in a state in which the second light reducer is placed at the position, changes the light attenuation ratios of the first light reducer and/or the second light reducer so as to fall within the light-receiving sensitivity of the light-receiving portion, and that calculates relative light attenuation ratios on the basis of ratios of intensities of light received by the light-receiving portion before and after changing the light attenuation ratios; and a light attenuation-ratio calculator that calculates a light attenuation ratio of the first light reducer by multiplying the relative light attenuation ratios calculated by the relative-attenuating-ratio calculator in in ascending order.

With this aspect, by placing the second light reducer in the optical path between the light-source unit and the light-receiving portion in a state in which the object-to-be-measured is not placed in the optical path, the transmitted light that has passed through both the first light reducer and the second light reducer is received by the light-receiving portion. The first intensity is measured in the first step by setting the light attenuation ratio of the first light reducer to be that of the first light attenuator and by setting the light attenuation ratio of the second light reducer to be that of the second light attenuator, the second intensity is measured in the second step by changing the light attenuation ratio of the first light attenuator to be that of the target light attenuator, and thus, it is possible to measure, in a highly precise manner, the light attenuation ratio of the target light attenuator on the basis of the light attenuation ratio of the first light attenuator, the first intensity, and the second intensity. Thus, by placing the object-to-be-measured in the optical path, by setting the light attenuation ratio of the first light reducer in the target light attenuator, and by irradiating the transmitted light, which has passed through the target light attenuator and which has been attenuated in a highly precise manner, onto the object-to-be-measured, it is possible to measure the light intensity.

The aforementioned aspects affords an advantage in that it is possible to calculate a light attenuation ratio in a highly precise manner even in a case in which a light-receiving portion having a small light-receiving dynamic range is employed.

### REFERENCE SIGNS LIST

A object-to-be-measured
S4 first step, second step, fourth step, fifth step
S11 third step, sixth step
S31 seventh step
S32 eighth step
1 light-intensity measurement system
2 light-source unit
6 second light reducer
7 light-receiving portion
8 controller (relative-light attenuation-ratio calculator, light attenuation-ratio calculator)
10 laser diode (light source)
17 first light reducer
17a light attenuator (first light attenuator, second light attenuator, third light attenuator, target light attenuator)

1. A light-attenuation-ratio measurement method comprising:
a first step of placing a first light attenuator and a second light attenuator between a light source and a light-receiving portion that receives light coming from the light source, and measuring a first intensity of transmitted light that has passed through the light attenuators, the first intensity being within a light-receiving sensitivity of the light-receiving portion;
a second step of placing the second light attenuator and a target light attenuator between the light source and the light-receiving portion, and measuring a second intensity of transmitted light that has passed through the light attenuators, the second intensity being within the light-receiving sensitivity of the light-receiving portion; and
a third step of calculating a light attenuation ratio of the target light attenuator by multiplying or dividing an intensity ratio between the first intensity and the second intensity by a light attenuation ratio of the first light attenuator.

2. The light-attenuation-ratio measurement method according to claim 1, further comprising:
a fourth step of placing a light attenuator having a light attenuation ratio of 1 or a transmittance of 100% and the third light attenuator between the light source and the light-receiving portion, and measuring a third intensity of transmitted light that has passed through the light attenuator having the light attenuation ratio of 1 or the transmittance of 100% and the third light attenuator, the third intensity being within the light-receiving sensitivity of the light-receiving portion;
a fifth step of placing the third light attenuator and the first light attenuator between the light source and the light-receiving portion, and measuring a fourth intensity of transmitted light that has passed through the third light attenuator and the first light attenuator, the fourth intensity being within the light-receiving sensitivity of the light-receiving portion; and
a sixth step of calculating a light attenuation ratio of the first light attenuator on the basis of the third intensity and the fourth intensity.

3. The light-attenuation-ratio measurement method according to claim 1, further comprising:
a fourth step of placing a third light attenuator between the light source and the light-receiving portion, and measuring a third intensity of transmitted light that has passed through the third light attenuator, the third intensity being within the light-receiving sensitivity of the light-receiving portion;
a fifth step of placing the third light attenuator and the first light attenuator between the light source and the light-receiving portion, and measuring a fourth intensity of transmitted light that has passed through the third light attenuator and the first light attenuator, the fourth intensity being within the light-receiving sensitivity of the light-receiving portion; and
a sixth step of calculating a light attenuation ratio of the first light attenuator on the basis of the third intensity and the fourth intensity.

4. The light-attenuation-ratio measurement method according to claim 1, wherein the light attenuation ratio of the target light attenuator is greater than the light attenuation ratio of the first light attenuator.

5. The light attenuation-ratio measurement method according to claim 2,
wherein a light attenuation ratio of the third light attenuator is greater than a light attenuation ratio of the second light attenuator,
the light attenuation ratio of the second light attenuator is greater than the light attenuation ratio of the target light attenuator, and
the light attenuation ratio of the target light attenuator is greater than the light attenuation ratio of the first light attenuator.

6. The light-attenuation-ratio measurement method according to claim 2,
wherein the fourth step and the fifth step are executed before executing the first step and the sixth step is executed before executing the third step,
in the second step, the target light attenuator is placed between the light source and the light-receiving portion instead of the first light attenuator, and,
in the first step, the second light attenuator is placed between the light source and the light-receiving portion instead of the third light attenuator.

7. The light-attenuation-ratio measurement method according to claim 6, further comprising:
a seventh step of setting the wavelength of the light emitted from the light source before executing the fourth step; and
an eighth step of repeating, after executing the third step, the fourth step, the fifth step, the sixth step, the first step, the second step, and the third step after changing the wavelength of the light emitted from the light source.

8. A light-intensity measurement system comprising:
a light-source unit that emits light that is irradiated onto an object-to-be-measured;
a light-receiving portion that receives light that has been irradiated onto the object-to-be-measured;
a first light reducer that is placed between the light-source unit and the light-receiving portion in order to attenuate light received by the light-receiving portion so as to fall within the light-receiving sensitivity of the light-receiving portion, the first light reducer capable of changing its light attenuation ratio;
a second light reducer that can be placed at and removed from a position between the light-source unit and the light-receiving portion, the second light reducer capable of changing its light attenuation ratio; and
a light attenuation-ratio calculator that, while changing the light attenuation ratios of the first light reducer and/or the second light reducer so as to fall within the light-receiving sensitivity of the light-receiving portion in a state in which the second light reducer is placed at the position, acquires a plurality of intensity ratios of the light received by the light-receiving portion before and after changing the light attenuation ratio of the first light reducer, and that calculates light attenuation ratios of the first light reducer by multiplying the intensity ratios, the light attenuation ratios of the first light reducer are calculated in ascending order of the light attenuation ratios.
